(19) United States
(12) Patent Application Publication
(10) Pub. No.: US 2026/0246138 A1
(43) Pub. Date: Aug. 20, 2026

(54) RFID DEVICE

(71) Applicant: ASSA ABLOY AB, Stockholm (SE)

(72) Inventors: Gilles Horisberger, Saint-Légier (CH); Hugo Kapp, Saint-Gingolph (FR); Urs Furter, Noville (CH); Osamn Bin Ayop, Kulai (MY)

(21) Appl. No.: 19/161,760

(22) PCT Filed: Mar. 8, 2023
(86) PCT No.: PCT/EP2023/055867

§ 371 Date: Sep. 3, 2025

(51) Int. Cl. H01Q 1/22; G06K 19/077; H01Q 7/00

(52) U.S. Cl. CPC H01Q 1/2216; G06K 19/07773; H01Q 7/00

(57) ABSTRACT

An RFID device (10) is provided. The RFID device (10) includes a first loop antenna (14) embedded in a device body (12), and a second loop antenna (16) embedded in the device body (12). The first loop antenna (14) and the second loop antenna (16) partially overlap each other by a set distance (d). This results in a suppression of a cross-coupling between the first loop antenna (14) and the second loop antenna (16), and allows for an optimum use of the space that is available for the antennas on the device body (12). In this manner, a reliable operation of the two antennas within desired communication ranges can be obtained.

### TECHNICAL FIELD

The present disclosure generally relates to radio frequency identification (RFID) devices, in particular, to an RFID device that comprises a plurality of RFID antennas.

### BACKGROUND

Generally, RFID devices such as, for example, RFID cards, RFID tags, etc. include an RFID antenna and an integrated circuit connected to the RFID antenna. Upon presence of an electromagnetic field emitted by a reader device, the RFID antenna supplies energy from the electromagnetic field to the integrated circuit, which integrated circuit may communicate with the reader device using radio frequency (RF) communication protocols. In this manner, for example, data can be read from a memory associated with the integrated circuit, and can also be written into said memory, if desired.

US 2008/0035741 A1 discloses an IC tag including a first inlet formed by patterning a first antenna mounting a first IC chip in a loop shape near an external periphery area of an IC card. A compact inlet including a second antenna, a second IC chip and a matching circuit is attached to a top or bottom surface of the card, crossing at a right angle a portion of the first loop antenna. With this antenna layout, the second antenna can be made compact by using the first antenna as an auxiliary antenna.

The present disclosure is directed, at least in part, to improving or overcoming one or more aspects of prior systems.

### SUMMARY OF THE DISCLOSURE

According to one aspect of the present disclosure, an RFID device comprises a device body, a first loop antenna embedded in the device body, the first loop antenna extending in a first plane, and a second loop antenna embedded in the device body. The second loop antenna partially overlaps the first loop antenna when viewed in a direction perpendicular to the first plane.

Other features and aspects of the present disclosure will become apparent from the following description and the accompanying drawings.

### BRIEF DESCRIPTION OF THE DRAWINGS

FIG. 1 is a plan view of an RFID device in accordance with the present disclosure,

FIG. 2 is a diagram illustrating an antenna coupling between two loop antennas in accordance with the present disclosure,

FIG. 3 is a plan view of another RFID device in accordance with the present disclosure, and

FIG. 4 is a plan view of another embodiment of an RFID device in accordance with the present disclosure.

### DETAILED DESCRIPTION

The following is a detailed description of exemplary embodiments of the present disclosure. The exemplary embodiments described herein are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of protection. Rather, the scope of protection shall be defined by the appended claims.

The present disclosure is based at least in part on the realization that, in applications where two or more RFID antennas, for example, two HF antennas, are provided in a single RFID device such as an RFID card, there may be interference between the two antennas, resulting in frequency shifts of the tuning frequencies of the antennas. For example, if an RFID card includes a first loop antenna operating at a tuning frequency of 15 MHz and a second loop antenna operating at a tuning frequency of 16 MHz, when both antennas are provided in one RFID card, the respective tuning frequencies may shift to 14 MHz and 17 MHz, respectively. However, this may result in a decrease in the performance of the RFID card. In particular, it has been realized that, in order to obtain a maximum possible communication range, the size of the individual antennas should be as large as possible. Conventionally, this is achieved by arranging the two antennas such that one is arranged inside the other, i.e., a first antenna covers a maximum possible area of the RFID card, and a second antenna is arranged inside the first antenna. This results in the above-described interference.

It has been realized that the above problems can be overcome or alleviated when the two loop antennas are provided such that there is only a partial overlap between the two antennas. In particular, it has been realized that, while the effects of the interference between the two antennas could also be reduced by arranging the two antennas such that they are relatively far apart from each other, this results in a substantial decrease in the size of the two antennas. On the other hand, it has been found that about the same effect of reducing the interference between the antennas can be obtained by providing the two antennas such that they partially overlap by a specific amount.

In this respect, it has also been realized that it is advantageous to provide the loop antennas with a shape that can be considered as substantially D-shaped, i.e., a shape that includes one or more linear portions extending along one or more outer edges of the RFID device, and a substantially arc-shaped section that is provided in the overlap region, in particular, closer to a central part of the RFID device. In this manner, the sizes of the respective antennas can be made as large as possible, while at the same time decreasing the interference between the same.

The present invention is also based on the realization that the above concept can be generalized to more than two antennas, for example, by providing a third antenna, for example, between the first antenna and the second antenna. In this case, at least one overlap region can be formed between the first antenna and the third antenna and/or between the third antenna and the second antenna, while obtaining a good performance of each of the antennas.

The present disclosure is also based at least in part on the realization that, when the two antennas are used for different applications, one application may require a considerably larger communication range than another application. In this case, it has been realized that the two antennas may have substantially different sizes, i.e., a first antenna for a larger communication range may be considerably larger than a second antenna for a smaller communication range. In this manner, it is possible to achieve a communication range of the first antenna of, for example, up to 0.5 to 1 m, whereas the second antenna may be used for applications in which a communication range of up to 0.1 m is sufficient. For example, the first application may be an access control application, where a holder of the RFID device wishes to pass through an entry or gate without having to bring the RFID device in close proximity to a reader. On the other hand, the second application may be, for example, an electronic ticket for a public transport system or the like, or a payment application, where the RFID device is usually brought in close proximity to the corresponding reader.

In addition, it has been realized that, although in the following an example will be described in which the two antennas are provided as part of an RFID card having a commonly used size, as prescribed by well-known standards (for example, about 85.6 mm×54 mm), the above and below described concepts can also be generalized to other RFID devices having different sizes and/or geometries. For example, this can be achieved by scaling the sizes and/or overlaps that are described below in an appropriate manner.

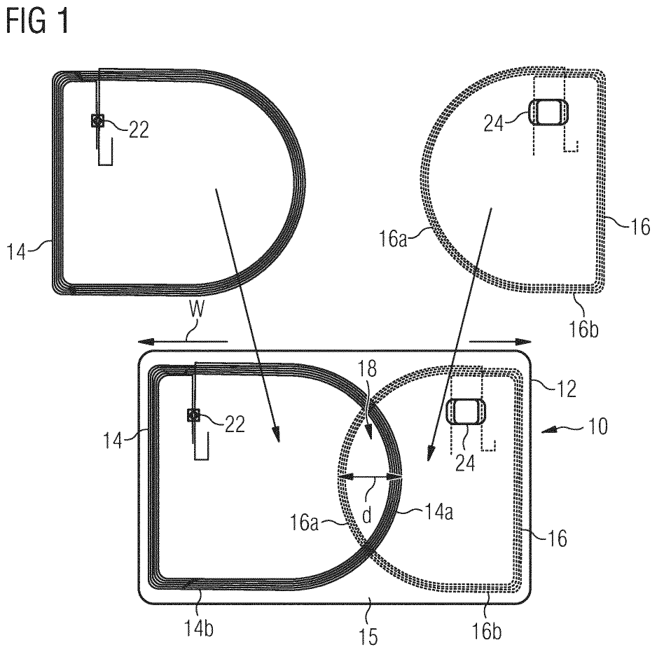

Referring now to the drawings, FIG. 1 shows a plan view of an RFID device 10 in accordance with the present disclosure. In the example shown in FIG. 1, RFID device 10 is configured as a substantially rectangular RFID card, which may be used as an access card, a debit card, a credit card, or the like. It will be appreciated, however, that RFID device 10 may also be configured with a different shape, for example, as an RFID tag, a token etc. Further, RFID device 10 may be used for any appropriate purpose, for example, to gain access to a building or the like, as a means for payment, as a means for identification of a user/holder of the RFID device, etc. The range of possible applications for such RFID devices are well-known and will therefore not be described in detail herein.

As shown in FIG. 1, RFID device 10 comprises a device body 12 formed in the shape of a substantially rectangular card or sheet. Device body 12 may be a polycarbonate or other substrate commonly used for RFID cards. Further, as shown in FIG. 1, RFID device 10 comprises a first loop antenna 14 embedded in device body 12. In particular, first loop antenna 14 extends in a first plane 15, which is parallel to top and bottom surfaces of device body 12 in the exemplary embodiment. However, it will be appreciated that, in other embodiments, this does not need to be the case.

RFID device 10 further comprises a second loop antenna 16 embedded in device body 12. Here, as shown in FIG. 1, second loop antenna 16 is provided such that it partially overlaps first loop antenna 14 when viewed in a direction perpendicular to first plane 15. For example, first loop antenna 14 may be provided in a known manner on a first layer of device body 12, and second loop antenna 16 may be arranged on a second layer of device body 12, with the second layer being provided above or below the first layer, and the layers being combined with each other to form RFID device 10. The provision of loop antennas such as loop antenna 14 and loop antenna 16 on respective substrates forming part of RFID device 10, for example, an RFID card, are well-known, such that a detailed description will be omitted. It will be appreciated, however, that the exemplary embodiment directed to the RFID card is not limiting the present disclosure, and that other arrangements of loop antennas 14, 16 are possible. For example, it is not absolutely necessary that second loop antenna 16 extends in a plane that is parallel to first plane 15. For example, second loop antenna 16 could extend in a plane that extends at an angle with respect to first plane 15. Likewise, the present disclosure is not limited to the exemplary RIFD card shown in FIG. 1, and RFID devices or device bodies having any appropriate shape or size can be used, depending on the desired applications.

As shown in FIG. 1, RFID device 10 further comprises a first integrated circuit 22 connected to first loop antenna 14 and configured to perform RFID communications via first loop antenna 14, and a second integrated circuit 24 connected to second loop antenna 16 and configured to perform RFID communications via second loop antenna 16. The connection of respective integrated circuits to respective loop antennas is well-known, as is the performance of RFID communications using such circuits. Therefore, a detailed description will be omitted herein. However, it will be appreciated that, generally, each combination of integrated circuit and loop antenna is configured to perform RFID communications in a given wavelength/frequency range, and within a communication range that is essentially determined by the size of the antenna.

This will be described in more detail below. However, it should be noted that, in accordance with the present disclosure, first loop antenna 14 and first integrated circuit 22 are configured to perform RFID communications for a different application than second loop antenna 16 and second integrated circuit 24, for example, at a different antenna tuning frequency, and, optionally, within a different communication range. It should also be noted that, in some embodiments, both first loop antenna 14 and second loop antenna 16 may be connected to a single integrated circuit, which single integrated circuit is configured to selectively perform RFID communications via first loop antenna 14 and second loop antenna 16.

As mentioned above, first loop antenna 14 and second loop antenna 16 are provided such that second loop antenna 16 partially overlaps first loop antenna 14 when viewed in a direction perpendicular to first plane 15. As used herein, the expression “partially overlaps” is understood such that the two antennas do not completely overlap with each other, or that one of the antennas is not provided inside an area that is covered by the other antenna. In other words, at least second loop antenna 16 has an overlap portion 16a overlapping first loop antenna 14 when viewed in a direction perpendicular to first plane 15, and a non-overlap portion 16b not overlapping first loop antenna 14 when viewed in the direction perpendicular to first plane 15. As shown in FIG. 1, in the exemplary embodiment, overlap portion 16a is part of an arc-shaped section of second loop antenna 16. However, it will be appreciated that this is not limiting the present disclosure, and overlap portion 16a could also be formed as one or more linear sections of second loop antenna 16, which could overlap, for example, an arc-shaped section of first loop antenna 14, or one or more linear sections could be provided to form the overlap part in each of the two antennas.

As shown in FIG. 1, in the exemplary embodiment, first loop antenna 14 is substantially D-shaped when viewed in the direction perpendicular to first plane 15. As used herein, “substantially D-shaped” refers to a shape in which three linear sections are connected to each other at angles of 90°, and the ends of opposing linear sections are connected to each other by an arc-shaped section, such as arc-shaped overlap portion 16a of second loop antenna 16, or a corresponding overlap portion 14a of first loop antenna 14. However, it will be appreciated that the D-shape shown in FIG. 1 is only an example, and other shapes of loop antennas 14, 16 may be used, for example, a rectangular shape, a polygon shape, a circular shape or an elliptical shape.

In particular with the D-shaped configuration of first loop antenna 14 and second loop antenna 16, it becomes possible to maximize the surface coverage of the respective antennas on a rectangular device body 12, as is the case for commonly used RFID cards. Here, first loop antenna 14 is arranged on one side of device body 12, with linear sections of the same extending along outer edges of device body 10, and arc-shaped overlap portion 14a being provided towards a center of device body 10. Likewise, second loop antenna 16 is arranged on the opposite side of device body 12, with linear sections of the same extending parallel to edges of device body 12, and arc-shaped overlap portion 16a extending towards the center of device body 12. In this manner, the sizes (areas) of the respective antennas can be maximized, while at the same time reducing the coupling via the overlapping parts at the center of device body 12.

As shown in FIG. 1, in accordance with the present disclosure, an optimized (maximum) dimension d of an overlap region 18 of loop antennas 14, 16 along a first direction in first plane 15 is between 0.05 and 0.25 times a total (maximum) dimension W of device body 12 along the first direction, and/or between around 5 mm and around 20 mm, preferably between around 10 mm and around 15 mm, in particular, around 13 mm. Here, it will be appreciated that, generally, there is a direction along which loop antennas 14, 16 are arranged (for example, a direction between two opposite ends of loop antennas 14, 16 in device body 12, or a direction along which device body 12 extends, such as a direction parallel to one of the sides of device body 12, as shown in FIG. 1), and that this direction is identified as the first direction, and the maximum dimension d is the dimension (length, extension) of overlap region 18 along this first direction. The same applies to the total dimension W of device body 12. In the example shown in FIG. 1, the total dimension W of device body 12 is a width of the same along the long side of the rectangular shape forming device body 12. Likewise, the first direction is the direction along the long side of device body 12. Overlap region 18 is formed close to the center of device body 12, with maximum dimension d being defined by the distance between adjacent ends of first loop antenna 14 and second loop antenna 16 along the first direction.

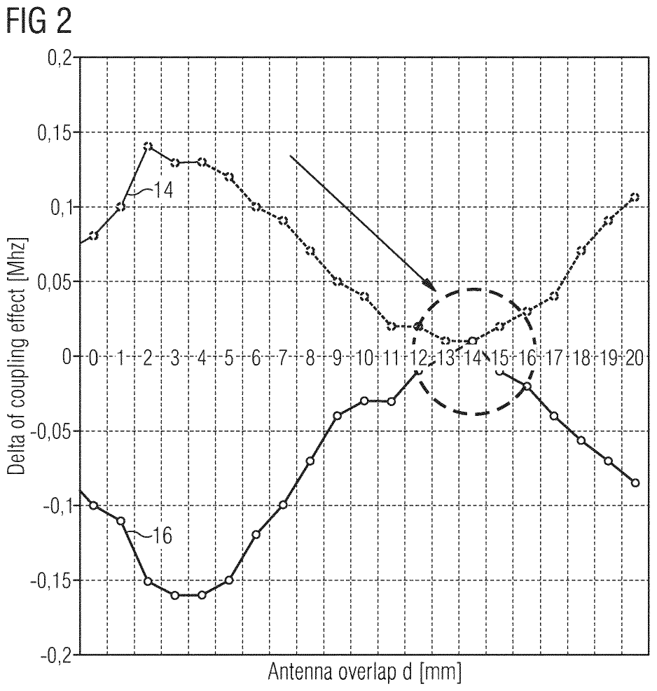

FIG. 2 shows a diagram illustrating a cross-coupling effect (i.e., a frequency shift due to the cross-coupling) of first loop antenna 14 and second loop antenna 16. Here, the delta shown in FIG. 2 corresponds to an observed frequency shift of the antennas with respect to the antennas that are provided separate from each other (as indicated in the upper part of FIG. 1). As can be seen in FIG. 2, it has been found that the frequency shift is at a maximum in case of a very small overlap, and decreases with an increase in the overlap, up to an optimum overlap of between around 5 mm and around 20 mm, preferably between around 13 mm and 15 mm, in case RFID device 10 is an RFID card having a standard size of about 85.6 mm×54 mm. As the overlap increases further, the frequency shift increases again. It has been found that the overlap between loop antennas 14, 16 should be between around 5 mm and around 20 mm, preferably between around 10 mm and around 15 mm, in particular, around 13 mm in order to minimize the coupling between the two antennas for such a standard RFID card.

As previously mentioned, the present disclosure is not limited to an application to RFID cards having standard sizes. For example, if RFID device 10 has a size that is also rectangular shaped, but smaller or larger than the standard card size, it is clear that the optimum overlap has to be scaled accordingly with the size of RFID device 10. Therefore, generally, it has been found that a minimized or optimized interference between loop antennas 14, 16 can be achieved when the maximum dimension d of overlap region 18 (i.e., the overlap) is, for example, between 0.05 and 0.25 times the total (maximum) dimension W of device body 12 along the first direction. Here, it is again pointed out that the shape of device body 12 is not limited to the rectangular shape shown in FIG. 1, but may be any arbitrary shape. Likewise, the shapes of first loop antenna 14 and second loop antenna 16 are not limited to the D-shape shown in FIG. 1.

Further, although in the example shown in FIG. 1 device body 12 is substantially planar, and first plane 15 is parallel to opposite surfaces of device body 12, this is not necessarily the case. Device body 12 can have any appropriate shape, for example, a spherical shape or a cube-like shape, and first plane 15 can be arranged at any desired orientation inside device body 12. In view of the desired performance, however, it will be appreciated that first plane 15 is generally arranged such that it has a maximum possible extension inside device body 12, in order to provide the maximum possible space for arranging first loop antenna 14 and second loop antenna 16, and that the above-mentioned first direction is generally a direction in first plane 15 extending from first loop antenna 14, for example, a center of first loop antenna 14, towards second loop antenna 16, for example, a center of second loop antenna 16). In this respect, however, it should again be pointed out that the plane in which second loop antenna 16 extends does not necessarily have to be parallel to first plane 15, depending, for example, on the shape of device body 12.

In some embodiments, at least one of first loop antenna 14 and second loop antenna 16 is an HF antenna configured to perform RFID communications within a range of between 0.1 m and 1.5 m (or 2 m) and at a tuning frequency of between around 13.5 MHz and about 18 MHz. In particular, first loop antenna 14 and second loop antenna 16 may be configured to perform RFID communications for different applications, in particular, at different antenna tuning frequencies of, for example, 15 MHz and 16 MHz. Here, in some embodiments, first loop antenna 14 and second loop antenna 16 may have substantially the same size, and, optionally, comprise substantially the same number of turns, for example, between two and ten turns.

In other embodiments, however, first loop antenna 14 and second loop antenna 16 may have substantially different sizes, for example, a maximum dimension of first loop antenna 14 being about 1.5 to 2 times a maximum dimension of second loop antenna 16 when viewed in the direction perpendicular to first plane 15. In other words, in the exemplary embodiment shown in FIG. 1, a size of first loop antenna 14 along the direction parallel to the long side of device body 12 may be about 1.5 to two times the corresponding size of second loop antenna 16. This allows for obtaining an increased communication range of first loop antenna 14, while reducing the communication range of second loop antenna 16. This may be useful and/or desirable in case first loop antenna 14 and second loop antenna 16 are used for different applications, for example, first loop antenna 14 being used for access control, and second loop antenna 16 being used for payment or ticketing applications. In this case, for example, first loop antenna 14 may have a communication range of up to 0.5 to 1 m, and second loop antenna 16 may have a communication range of between 2 and 10 cm. Likewise, the number of turns may also be different for first loop antenna 14 and second loop antenna 16.

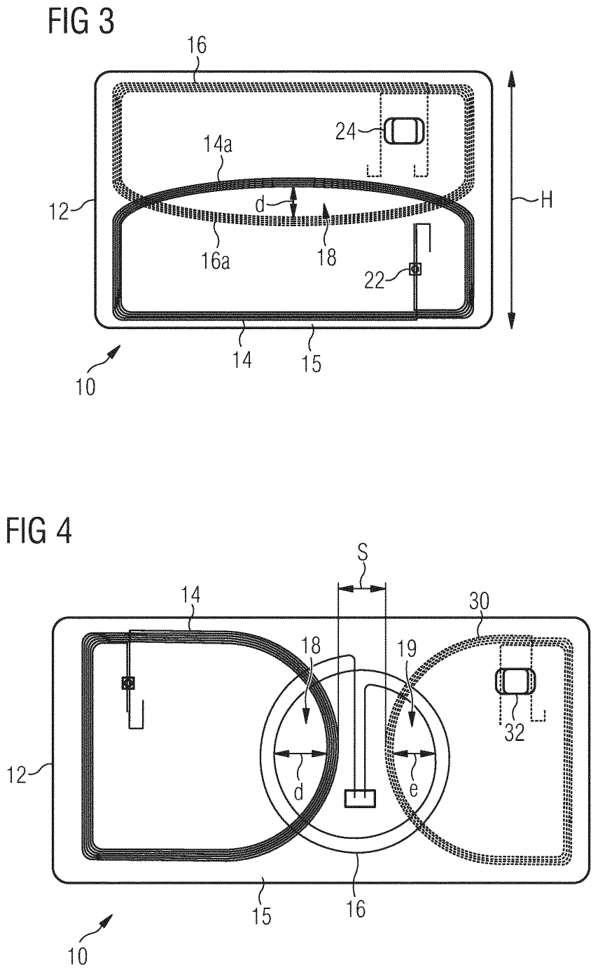

FIG. 3 shows another RFID device 10 in accordance with the present disclosure. The RFID device shown in FIG. 3 is essentially similar to the RFID device 10 shown in FIG. 1, except for the arrangement of the loop antennas. In the embodiment shown in FIG. 1, loop antennas 14, 16 are arranged along the long side of rectangular-shaped device body 12. In contrast, in the embodiment shown in FIG. 3, loop antennas 14, 16 are arranged along the short side of device body 12. In other words, extended linear sections of loop antennas 14, 16 extend along the long sides of rectangular-shaped device body 12 on opposite sides of the same in a height direction H of device body 12. Again, in some embodiments, RFID device may be a standard size card with a size of about 85.6 mm×54 mm. However, as mentioned above, the size of RFID device 10 is not limited to such a standard size, and the overlap d that will be discussed in the following can be scaled accordingly to the size of RFID device 10 without departing from the present disclosure.

In the embodiment shown in FIG. 3, maximum dimension d of overlap region 18 of loop antennas 14, 16 along a first direction in first plane 15 is between 0.10 and 0.40 times a maximum dimension H of device body 12 along a first direction, and/or between around 5 mm and around 20 mm, preferably between around 10 mm and around 15 mm, in particular, around 11 mm for the standard card size.

From the above, it will also be appreciated that the first direction of the present disclosure, which essentially defines the overlap d (i.e., the maximum dimension or length of this overlap along the designated first direction) is an appropriately selected direction, in particular, in the first plane 15. Here, in case of a rectangular-shaped device body 12, it will be appreciated that the directions extending in parallel to the long sides and the short sides of device body 10, respectively, are obvious choices for the first direction, i.e., the direction along which first loop antenna 14 and second loop antenna 16 are arranged. Of course, it will also be appreciated that for device bodies 12 having different shapes, for example, round or elliptical shapes, there are other appropriate choices for the first direction, for example, a diameter of a round device body 12, or a maximum dimension of an elliptical-shaped device body 12, and the like. Generally, the first direction (i.e. the direction of arrangement of loop antennas 14, 16) will be selected such that the loop antennas can cover a maximum area on device body 12, i.e., loop antennas 14, 16 will be arranged on device body 12 such that they can cover a maximum area. Obviously, in particular for the D-shaped loop antennas 14, 16 shown in FIG. 3, this will be the case when the first direction is either along the long side or along the short side of rectangular device body 12.

The arrangement shown in FIG. 3 may have an advantage over the arrangement shown in FIG. 1 in that, when a user holds device body 12, the user may be inclined to hold device body 12 at a position that is in the vicinity of one of the short sides of the same. In this case, however, the performance of one of loop antennas 12, 14 may be decreased with respect to the performance of the other one of loop antennas 14, 16. Obviously, this can be mitigated with the arrangement that is shown in FIG. 3.

Also in the embodiment shown in FIG. 3, loop antennas 14, 16 may have different sizes, as described above, while the size of overlap region 18 may essentially remain the same. For example, in the embodiment shown in FIG. 3, in case of a standard card, maximum dimension d of overlap region 18 may be between 5 and 20 mm, for example, around 11 mm, regardless of the sizes of loop antennas 14, 16.

FIG. 4 shows another embodiment in accordance with the present disclosure, where a third loop antenna 30 is embedded in device body 12, such that RFID device 10 can be used for three different applications. Here, third loop antenna 30 may again be connected to an integrated circuit 32 in a known manner. As shown in FIG. 4, third loop antenna 30 partially overlaps second loop antenna 16 when viewed in the direction perpendicular to first plane 15. For example, at least one of first loop antenna 14 and third loop antenna 30 may be D-shaped, similar to the embodiment shown in FIG. 1, while second loop antenna 16 may be rectangular, circular, or elliptical, and may overlap both first loop antenna 14 and third loop antenna 30. Again, maximum dimension d of overlap region 18 may be set in the above-described manner, and the same applies to a maximum dimension e of an overlap region 19 formed between second loop antenna 16 and third loop antenna 30. At the same time, distal ends of first loop antenna 14 and third loop antenna 30 may be separated from each other by a distance S, which may be similar to maximum dimensions d and e, as shown in FIG. 4.

It will be appreciated that the exemplary number of antennas in FIG. 4 is only an example and not limiting. Accordingly, in other embodiments, more than three antennas can be provided on device body 12, with a corresponding overlap between at least two adjacent antennas, as long as the desired communication range for each antenna can be assured. Here, it will be appreciated that the arrangement of the individual antennas is not limited to the arrangement along the first direction as shown in FIG. 4. In other words, for example, third loop antenna 30 could extend at an angle with respect to first loop antenna 12, or three or more loop antennas could be arranged in a star shape to overlap each other in a common central overlap region.

### Industrial Applicability

As described above, with the RFID device according to the present disclosure, it becomes possible to arrange two or more loop antennas that are used for different applications on a single RFID device, for example, an RFID card. By providing the two or more loop antennas such that they overlap by a given distance, an interference between the two antennas can be minimized or reduced, and a desired communication range can be obtained by an optimum use of the available space on the RFID device. In particular, two or more applications performing RFID communications in respective optimum antenna tuning frequency ranges between 13.5 MHz and 18 MHz can be provided on the same device, without undesired frequency shifts occurring due to interference between the antennas. This allows for reliably providing different functions of the RFID device, for example, for use in access control applications and ticketing or payment applications.

It will be appreciated that the foregoing description provides examples of the disclosed systems and methods. However, it is contemplated that other implementations of the disclosure may differ in detail from the foregoing examples. All references to the disclosure or examples thereof are intended to reference the particular example being discussed at that point and are not intended to imply any limitation as to the general disclosure.

Recitation of ranges of values herein are merely intended to serve as a shorthand method for referring individually to each separate value falling within the range, unless otherwise indicated herein, and each separate value is incorporated into the specification as if it were individually recited herein. All method steps described herein can be performed in any suitable order, unless otherwise indicated or clearly contradicted by the context.

Although the preferred embodiments of the present disclosure have been described herein, improvements and modifications may be incorporated without departing from the scope of the following claims.

1. An RFID device comprising:
a device body;
a first loop antenna embedded in the device body, the first loop antenna extending in a first plane; and
a second loop antenna embedded in the device body, wherein the second loop antenna partially overlaps the first loop antenna when viewed in a direction perpendicular to the first plane.

2. The RFID device of claim 1, wherein the second loop antenna has an overlap portion overlapping the first loop antenna when viewed in the direction perpendicular to the first plane, and a non-overlap portion not overlapping the first loop antenna when viewed in the direction perpendicular to the first plane.

3. The RFID device of claim 2, wherein the overlap portion is part of an arc-shaped section of the second loop antenna.

4. The RFID device of claim 1, wherein at least one of:
the first loop antenna is substantially D-shaped when viewed in the direction perpendicular to the first plane; or
the second loop antenna is substantially D-shaped when viewed in the direction perpendicular to the first plane.

5. The RFID device of claim 1, wherein a maximum dimension of an overlap region of the first and second loop antennas along a first direction in the first plane is between 0.05 and 0.40 times a maximum dimension of the device body along the first direction.

6. The RFID device of claim 5, wherein the device body is substantially rectangular-shaped, and the first direction is parallel to a long side or a short side of the device body along which the first and second loop antennas are arranged.

7. The RFID device of claim 5, wherein the first direction is a direction extending from a center of the first loop antenna towards the second loop antenna in the first plane.

8. The RFID device of claim 1, wherein at least one of the first loop antenna and the second loop antenna (16) is an HF antenna configured to perform RFID communications within a range of between 0.1 m and 1.5 m and at a tuning frequency of between about 13.5 MHz and about 18 MHz.

9. The RFID device of claim 8, wherein the first loop antenna and the second loop antenna are configured to perform RFID communications for different applications at different tuning frequencies.

10. The RFID device of claim 1, wherein the first loop antenna and the second loop antenna have substantially the same size.

11. The RFID device of claim 1, wherein the first loop antenna and the second loop antenna have different sizes, a maximum dimension of the first loop antenna being about 1.5 to 2 times a maximum dimension of the second loop antenna when viewed in the direction perpendicular to the first plane.

12. The RFID device of claim 1, further comprising a first integrated circuit connected to the first loop antenna and configured to perform RFID communications via the first loop antenna, and a second integrated circuit connected to the second loop antenna and configured to perform RFID communications via the second loop antenna.

13. The RFID device of any one of claim 1, further comprising an integrated circuit connected to the first loop antenna and the second loop antenna and configured to selectively perform RFID communications via the first loop antenna and the second loop antenna.

14. The RFID device of claim 1, further comprising a third loop antenna embedded in the device body, wherein the third loop antenna partially overlaps the second loop antenna when viewed in the direction perpendicular to the first plane.

15. The RFID device of claim 14, wherein at least one of the first loop antenna and the third loop antenna is D-shaped, and the second loop antenna is rectangular, circular, or elliptical.

16. The RFID device of claim 1, wherein a maximum dimension of an overlap region of the first and second loop antennas along a first direction in the first plane is between around 5 mm and around 20 mm.
